(19) United States
(12) Patent Application Publication
(10) Pub. No.: US 2008/0082416 A1
(43) Pub. Date: Apr. 3, 2008

(54) Community-Based Selection of Advertisements for a Concept-Centric Electronic Marketplace

(76) Inventors: Paul A. Kotas, Seattle, WA (US); Joseph C. Park, Redmond, WA (US)

Correspondence Address: LEE & HAYES, PLLC, 421 W. RIVERSIDE AVE, STE 500, SPOKANE, WA, 99201, US

(21) Appl. No.: 11/615,820

(22) Filed: Dec. 22, 2006

Related U.S. Application Data
(63) Continuation-in-part of application No. 11/537,320, filed on Sep. 29, 2006.

(51) Int. Cl. G06Q 30/00

(52) U.S. Cl. 705/14

(57) ABSTRACT

A domain that hosts a general e-commerce marketplace establishes multiple sub-domains to host niche electronic marketplaces. These niche sub-domain sites are built around a concept and offer for sale items that relevant to that concept. The sub-domain sites are operated by communities of individuals. Each community is responsible for determining many facets of the consumer experience at the sub-domain site. The community might, for example, select the items to offer for sale, specify the look and feel of the site, determine what content should be presented (e.g., professional-level commentary, community-based discussion forums, wiki-like product descriptions, blogs, and so forth), and manage the overall operation of the site. The community further determines which advertisements to place on the sub-domain sites and how to distribute any revenue generated by the site among the community members.

### RELATED APPLICATION

This is a continuation-in-part (CIP) of U.S. patent application Ser. No. 11/537,320, entitled “Tag-Driven Concept-Centric Electronic Marketplace”, which was filed on Sep. 29, 2006, and is hereby incorporated by reference.

### BACKGROUND

Consumers are familiar with electronic marketplaces that offer for sale a wide range of products. Such marketplaces face unique problems when trying to connect consumers with seemingly countless products. Unlike traditional brick-and-mortar businesses, e-commerce sites do not have a physical store or location where a salesperson can help both novice and knowledgeable customers find sought after products. In the web environment, it is the customer's responsibility to identify a product that meets his or her needs. Even customers with considerable experience navigating e-commerce websites sometimes find it difficult to locate a desired product from among hundreds or thousands of offered products. For novice customers, the task of shopping online via the web can be unproductive and even frustrating.

E-commerce companies continue to look for ways to market a large selection of products to a wider audience. However, with an ever-enlarging product catalog and a growing customer base, it becomes increasingly difficult to satisfy the preferences of all customers who shop at the website. This is particularly true when trying to appease both the generalist shoppers and the hobbyist shoppers. Generalist shoppers are those who are simply trying to locate a type of product and any brand might do. These shoppers might be interested in learning a little about the various brands, and may even be willing to compare one or two products, but that is the extent of their involvement. In contrast, the hobbyist shoppers are those who are very familiar with the products and want to learn everything they can prior to making a purchase. They prefer to see specifications, compare features, and maybe even discuss the items with other hobbyists. Due to these differences, general e-commerce sites tend to appeal more to the generalist shoppers than to the hobbyist shoppers.

Online advertisers also have an interest in identifying types of potential shoppers with more particularity. Advertisements may be crafted differently when targeted at generalist shoppers as opposed to hobbyist shoppers.

Accordingly, there continues to be a need for improving the e-commerce experience across a wide and diverse customer base.

### SUMMARY

A domain that hosts a general e-commerce marketplace also establishes multiple sub-domains to host concept-centric electronic marketplaces. These niche sub-domain sites are built around a concept and offer for sale items relevant to that concept. The items may be selected from the general e-commerce marketplace at the host domain, or from other websites.

The sub-domain sites are operated by communities of individuals. Each community is responsible for determining many facets of the consumer experience at the sub-domain site. The community might, for example, select the items to offer for sale, specify the look and feel of the site, determine what content should be presented (e.g., professional-level commentary, community-based discussion forums, wiki-like product descriptions, blogs, and so forth), and manage the overall operation of the site.

The community further determines which advertisements to place on the sub-domain sites. These advertisements may be manifest as banner ads, pop-up ads, sponsored links, or other mechanisms used to entice consumers to purchase products or services relevant to the concepts around which the sites are developed.

The sale of items and the placement of offers and advertisements may generate revenue for the communities in charge of the sub-domain sites. These communities may enter into a business relationship to share revenue with the host domain operator. Additionally, each community responsible for a single sub-domain site may also establish revenue sharing amongst the individuals in the community.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an example architecture for implementing a tag-driven concept-centric electronic marketplace. The architecture includes multiple clients coupled via a network to one or more server systems that host a root domain with an electronic catalog as well as one or more sub-domains with concept-centric electronic catalogs.

FIG. 2 illustrates a screen rendering of an exemplary home page for an electronic marketplace found at the root domain.

FIG. 3 illustrates a screen rendering of an exemplary home page for a concept-centric electronic marketplace found at a sub-domain.

FIG. 4 is a block diagram illustrating selected modules in the server system that hosts the electronic marketplace found at the sub-domain.

FIG. 5 illustrates a screen rendering of a first exemplary page of an item tagging tool that facilitates searches for items to be included at the concept-based electronic marketplace.

FIG. 6 illustrates a screen rendering of a second exemplary page of an item tagging tool that facilitates identification and tagging of the items.

FIG. 7 illustrates an example architecture in which a community of members collectively operates, manages, and/or otherwise contributes to the tag-driven concept-centric electronic marketplace.

FIG. 8 illustrates a screen rendering of an exemplary page for an ad selection tool that facilitates community-based review and selection of advertisements to be placed on the concept-based electronic marketplace.

FIG. 9 illustrates a screen rendering of an exemplary page for a revenue tool that facilitates community-determined allocation of revenue to various contributors in the community.

FIG. 10 is another block diagram of the server system of FIG. 4, but shows other selected modules that implement community-based selection of advertisements and revenue sharing models for the community.

FIG. 11 is a flow diagram of a process for launching and operating a concept-centric electronic marketplace.

FIG. 12 is a flow diagram of a process for determining which advertisements to position on the electronic marketplace.

FIGS. 13 and 14 illustrate exemplary revenue sharing models for selling items through a concept-centric electronic marketplace found at the sub-domain.

FIG. 15 illustrates how revenue generated by the concept-centric electronic marketplace is collected and distributed to a community of contributors.

### DETAILED DESCRIPTION

This disclosure is directed to electronic marketplaces accessible via a network, such as the Internet. Such marketplaces are often called e-commerce or merchant websites and, in the case of the Internet, are located at various domains across the World Wide Web. In particular, the following discussion pertains to electronic marketplaces that are developed around a concept or niche.

As an overview, each concept-centric electronic marketplace is launched as a sub-domain of a host domain, where the host domain may itself host a merchant website. As one example, suppose there are one or more sub-domains created from a root domain with a domain name of “domain.com”. The sub-domains might be given domain names such as “concept1.domain.com”, “concept2.domain.com”, and so on, where the “concept1” and “concept2” portions of the domain names pertain to various concepts around which the electronic marketplaces are designed.

The concept-centric electronic marketplaces may offer for sale items that are related to that concept or niche. Such items are identified and associated with the marketplace by assigning semantic information related to the concept. In one implementation, the items are assigned one or more semantic tags related to the concept. Tags are pieces of information separate from, but related to, the items. Each item is assigned at least one primary tag that associates the item with the sub-domain site. The primary tag is selected by the site operator who is establishing the concept-centric electronic marketplace. In one implementation, the tag applied to the items is identical to a portion of the sub-domain name. Continuing our example, items that appear on the electronic marketplace at “concept.domain.com” are thus assigned the tag “concept”. For instance, suppose the concept for one electronic marketplace is to sell jewelry and the concept for another electronic marketplace is to sell items that are black. The sub-domains for these marketplaces might be “jewelry.domain.com” and “black.domain.com”, with the corresponding primary tags being “jewelry” and “black”.

The items may further, or alternatively, be assigned one or more secondary tags that are not identical to the name portion of the sub-domain, but are nevertheless related to the concept. These secondary tags might include descriptors to characterize or otherwise describe attributes of the items. The secondary tags may be chosen by the operator when establishing the sub-domain site, or in a collaborative environment, by a community of individual contributors. For instance, for the jewelry-based electronic marketplace at “jewelry.domain.com”, the items made available at that site might be assigned tags such as “rings”, “necklaces”, and “diamonds”. With this additional flexibility, the site operator (or users of the site) can assign tags that are descriptive and might also specify properties of an item that may not otherwise be obvious from the item itself. Permitting different tags that are nonetheless associated with the concept enables the electronic marketplace to better support customer navigation, content searching, and item comparison.

In some cases, the concept-centric marketplaces may be multi-merchant marketplaces. Thus, each single item may also have one or more listings or offers to sell that item. Such offers may include charge-per-click offers.

In other cases, the concept-centric electronic marketplaces may present advertisements pertaining to the concept, rather than offering items for sale. In the situation where a community of individuals collectively operates the sub-domain, the community may select which advertisements to place on the marketplace and further distribute any revenue resulting from the ad placement to the individual contributors.

Once established, the concept-centric electronic marketplace found at the sub-domain can support additional features to provide a rich user experience. The site may include commentary and analysis on the various items. Shoppers may be permitted to compare and contrast various items. The electronic marketplace may further provide a collaboratively-defined item encyclopedia, where users author descriptions of new items or edit existing item descriptions authored previously by themselves or others. As a result, the item descriptions become more accurate and uniform over time, thereby improving the user's ability to find items of interest on the electronic marketplace. Through this collaboration, users might be further empowered to define additional tags that characterize the items and identify attributes of the items. Over time, the collaboratively defined tags form a folksology (an attributed folksonomy) to categorize the items offered at the marketplace. Once assigned to items, the tags may be used to locate and organize the items, as well as facilitate comparison of various items.

For purposes of discussion, the tag-driven concept-centric electronic marketplace is described in the following exemplary environments in which items are offered for sale and/or placement of advertisements serves as the revenue model rather than item sales.

Example System Architecture

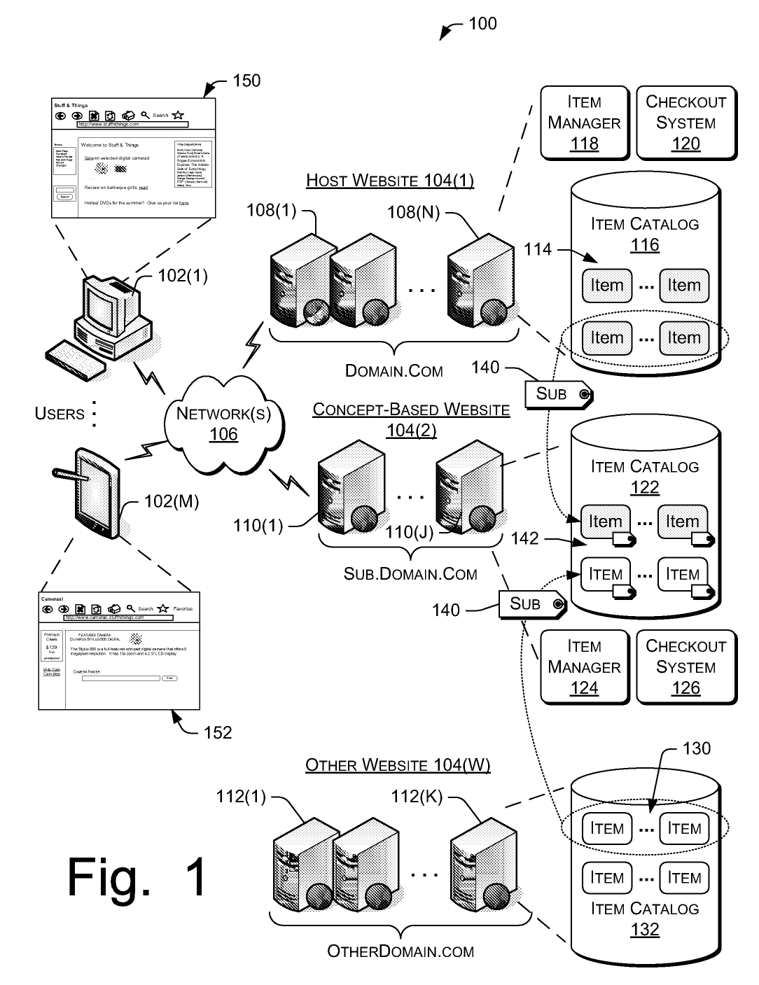

FIG. 1 illustrates an example architecture 100 in which a tag-driven concept-centric electronic marketplace may be implemented. In architecture 100, many user computing devices 102(1), . . . , 102(M) can access websites 104(1), 104(2), . . . , 104(W) via a network 106. The network 106 is representative of any one or combination of multiple different types of networks, such as cable networks, the Internet, and wireless networks.

Each website 104(1)-104(W) is hosted on one or more servers. In the illustrated arrangement, the website 104(1) is hosted on one or more servers 108(1), . . . , 108(N), the website 104(2) is hosted on one or more servers 110(1), . . . , 110(J), and the website 104(W) is hosted on one or more servers 112(1), . . . , 112(K). In one implementation, the servers might be arranged in a cluster or as a server farm, although other server architectures may also be used to host the site. Each website is capable of handling requests from many users and serving, in response, various web pages that can be rendered at the user computing devices 102(1)-102(M). The websites 104(1)-104(W) can be essentially any type of website that offers items for sale, including online retailers, informational sites, weblog sites or “blogs”, search engine sites, news and entertainment sites, and so forth.

In the exemplary environment, the website 104(1) represents a merchant website that hosts an electronic catalog with one or more items. An item can be anything that the merchant wishes to offer for sale, or that others using the merchant's website wish to offer for sale. An item can include a product, a service, or some other type of sellable unit.

In FIG. 1, a collection of item records 114 are stored in an item catalog database 116, which is accessible, directly or indirectly, by one or more of the servers 108(1)-108(N). Each item record 114 contains information about an associated item being offered for sale on the merchant website 104(1). For products such as books or music CDs, for example, the item record may contain a description, images of the product, author/artist names, publication data, pricing, shipping information, and so forth. For other types of items, the item record may contain different information appropriate for those items.

An item manager 118 facilitates access to and management of the item records 114 in the catalog 116. The item manager 118 allows the website operator to add or remove items to the catalog 116, and generally maintain control of the items offered on the website 104(1). When a user requests information on an item from the website 104(1), one or more servers 108(1)-108(N) retrieve the item information from the item catalog 116 and serve one or more web pages containing the information to the requesting user computing device. The database 116 may therefore contain static web pages that are pre-generated and stored prior to such requests, or alternatively store data that is used to populate dynamic web pages that are generated in response to such requests.

The merchant website 104(1) also has a checkout system 120 that processes customers' purchases of items from the item catalog 116. The checkout system 120 facilitates user confirmation of items for purchase, collects payment and shipping information from the customers, provides electronic receipts to the customers, and then hands off delivery of the purchase to a fulfillment system (not shown).

Together, the servers 108(1)-108(N), item catalog database 116, item manager 118, and checkout system 120 form an electronic marketplace that resides at a specific domain on the Internet. For discussion purposes, suppose that the domain has a domain name identified by the URL (universal resource locator) “domain.com”.

A second website 104(2) represents another e-commerce website that hosts an electronic catalog with one or more items. The second website 104(2) is hosted on one or more servers 110(1)-110(J) and has its own item catalog database 122, item manager 124, and checkout system 126 that is separate from those of the host website 104(1). Together, the servers 110(1)-110(J), item catalog database 122, item manager 124 and checkout system 126 form another electronic marketplace that resides on the Internet. This marketplace is a concept-centric marketplace that is developed around a concept or theme. Hence, the second website 104(2) may be referred to as a concept-centric website. Items offered on the concept-centric website 104(2) relate to the concept. For instance, the concept might be jewelry, and the concept-centric marketplace is developed around the niche of selling jewelry online.

The concept-centric website 104(2) is formed as a sub-domain of the host domain website 104(1). In the Domain Name System (DNS) hierarchy, a sub-domain is a domain that is part of a larger domain. The DNS stores and associates many types of information with domain names, and translates domain names to IP addresses. In the illustrated example, the sub-domain has a domain name identified by “sub.domain.com”, which is a sub-domain of “domain.com” as exemplified by the naming structure of a prefix word “sub”, followed by a separating dot “.”, followed by the domain name “domain.com”. It is noted that the sub-domain website 104(2) may be physically hosted on the same set of servers used to host the first website 104(1) (i.e., the servers 108 and 110 are all part of the same server system) or hosted on separate servers that are still owned and operated by a common entity (i.e., such as the merchant that owns the merchant website 104(1)). Alternatively, the sub-domain website 104(2) may be physically hosted on servers 110 that are independent from servers 108, and separately owned and operated.

A third website 104(W) illustrated in FIG. 1 represents other possible merchant websites that host their own item catalogs with one or more items. A collection of item records 130 are stored in an item catalog database 132, which is accessible, directly or indirectly, by one or more of the servers 112(1)-112(K). The third website provides another electronic marketplace that resides on the Internet at a domain named, for example, “otherdomain.com”.

Returning again to the concept-centric website 104(2), it forms an electronic marketplace where item selection, merchandising, and marketing are provided by a different party than the owner/operator of the host website 104(1). Even though the concept-centric website 104(2) is a sub-domain of the host website, the third party owner and operator develops the theme, look and feel, and user experience independently of the host website. To launch the sub-domain site 104(2), the operator registers with the host domain to reserve a particular sub-domain. The sub-domain operator may also register the one or more tags used to identify items to be sold via the sub-domain's marketplace. The sub-domain operator may also provide information to support revenue sharing in the event that items provided by the host merchant website are sold on the concept-centric marketplace of the sub-domain. This registration might be done, for example, by visiting a registration location online at the host website 104(1).

The sub-domain operator may consist of a single person, a community of people, a single legal entity, or multiple entities. As one example, a group of part-time hobbyists might come together to form an electronic marketplace based on their hobby, and the work collectively together to manage, merchandise, and update the sub-domain site. The sub-domain may also be established as a non-profit legal entity so that revenue derived from selling items flows to the benefit of the non-profit organization or some other cause. In implementations described below, the sub-domain operator is a community of individual who collectively operate, manage, and/or otherwise contribute to the tag-driven concept-centric electronic marketplace.

Once the concept-centric website 104(2) is built, the operator decides what types of items will appear on the site to fit within the concept. The items may be existing items already being offered on the host website 104(1) as well as items being offered on one or more other websites 104(W). In one implementation, the sub-domain operator identifies items that will appear on the concept-centric site 104(2) by searching other websites, including at “domain.com” hosted by the host website 104(1) and at other websites 104(W). Once items are identified, the sub-domain operator associates tags with those items. The tags relate to the concept. Any number of tags may be used and associated with the items selected.

In FIG. 1, the identification and tagging of items is pictorially represented by selection of certain item records 114 in the item catalog 116 hosted by website 104(1) and available at “domain.com”, and certain item records 130 in the item catalog 132 hosted by the other website 104(W). These selected item records are assigned tags 140 and stored as records 142 in the item catalog 122 associated with the concept-centric website 104(2). It is noted that the item catalog 122 may, in some implementations, be a logical subset of the item catalog 116, and hence run on the same platform.

As illustrated in FIG. 1, one tag assigned to the items has a name identical to the prefix portion of the sub-domain name. That is, suppose the sub-domain has a name structure of “sub.domain.com”, where the prefix “sub” portion defines, at least in part, the concept. One of the tags 140 is the word “sub” to identically match the prefix portion of the domain name. So, if the concept is jewelry, the sub-domain might be “jewelry.domain.com” and one of the tags 140 assigned to the items to be sold on the sub-domain is “jewelry”. Other tags 140 might include “rings”, “bracelets”, and “diamonds”. Similarly, if the concept is goods that are black, the sub-domain might be “black.domain.com” and one of the tags 140 assigned to items to be sold on “black.domain.com” is “black”.

Once the items are selected and tagged, the concept-centric sub-domain site is ready to launch. Users can then access the concept-centric electronic marketplaces at “sub.domain.com” independently of the marketplace hosted by the host website 104(1). Indeed, it is anticipated that the marketplaces would have a different look and feel so that the users may not even know that the two domains are affiliated in a domain and sub-domain relationship.

As shown in FIG. 1, user 102(1) may access the electronic marketplace at “domain.com” and be presented with one web page 150. Through that web page, the user can search for any number of items in the item catalog 116. Meanwhile, another user 102(M) might access the concept-centric electronic marketplace at “sub.domain.com” and be presented with another web page 152 that facilitates shopping of items in item catalog 122.

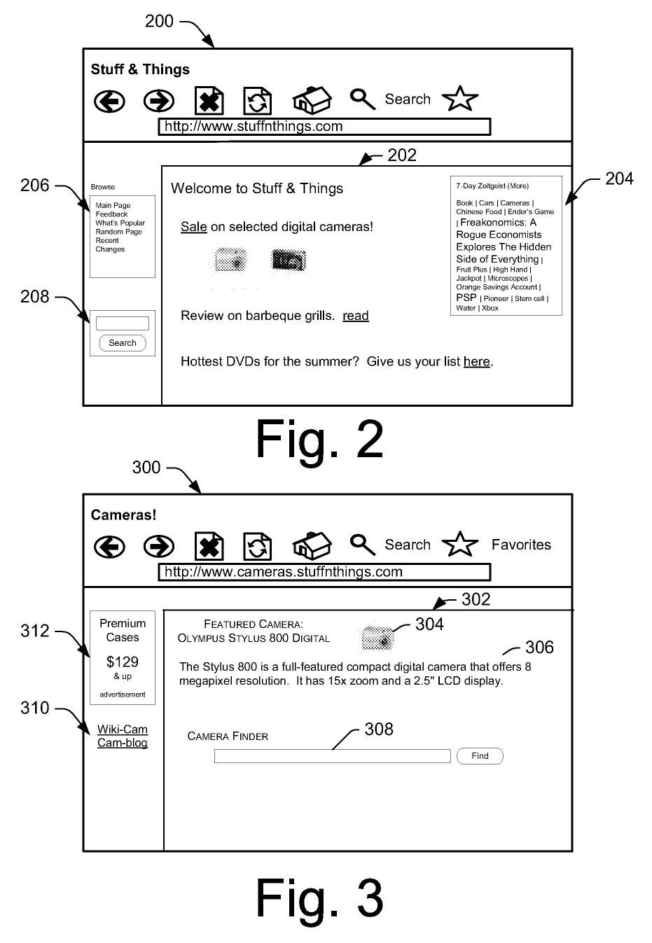

To better illustrate the user experience when visiting the two different marketplaces, FIGS. 2-3 show renderings of various web pages served by the domain website 104(1) and the sub-domain website 104(2). In this example, a general electronic marketplace is found at a fictional domain called “stuffnthings.com”. This general marketplace has a large item catalog that offers many different types of goods and services. A concept-centric electronic marketplace is found at a fictional sub-domain called “cameras.stuffnthings.com”, where the concept pertains to cameras.

FIG. 2 shows an example web page 200 that might be served and rendered, for example, when the user first accesses the general electronic marketplace at the domain named “stuffnthings.com” hosted by website 104(1). The web page 200 includes a welcome pane 202 with a greeting and a listing of special features currently available at the general electronic marketplace. In this example, the special features include a sale on selected digital cameras, a review of various barbeque grills, and an invitation for the user to provide his or her list of the 10 best summertime movies available on DVD. The web page 200 might also contain other controls or navigation tools, such as a zeitgeist 204 listing the most popular or interesting tags over the past seven day period, a list of navigation links 206, and a search tool 208.

The search tool 208 allows the user to locate items in the item catalog 116. By entering one or more key terms, users can search that catalog 116 in an effort to identify possible items matching those key terms. If one or more items exist, the website serves a web page with information about the item. The user may also access other web pages with product offerings by following the navigation links 206 or links provided in the zeitgeist 204.

FIG. 3 shows a rendering of web page 300 that might be served and rendered, for example, when a user first accesses the concept-centric niche marketplace at the sub-domain named “cameras.stuffnthings.com” hosted by website 104(2). Since this marketplace is developed around the concept of cameras, the content served in the web pages relate in some manner to cameras. Stated differently, this niche marketplace is all about cameras and the site operator focuses essentially exclusively on cameras and camera related items. The branding, color scheme, layout, and other look-and-feel components of the graphical user interface may be entirely different that that of the web pages 200 pertaining to the general marketplace, even though the concept-centric marketplace is a sub-domain of the domain for the general electronic marketplace. Moreover, the concept-centric marketplace might provide commentary, analysis, reviews, comparisons, and such about cameras. Through this differentiation, the user is given a different shopping experience when exploring cameras at this concept-centric marketplace in comparison to searching for cameras at the general marketplace.

In this illustration, the web page 300 includes a feature pane 302 that features one particular digital camera (i.e., “Olympus Stylus 800 Digital”). This feature pane 302 includes an image 304 of the camera and a brief description 306. The feature pane 302 further includes a search tool 308 that invites the user to search for other cameras available at the concept-centric marketplace or to locate information on cameras in general, regardless of whether they are offered for sale on the site.

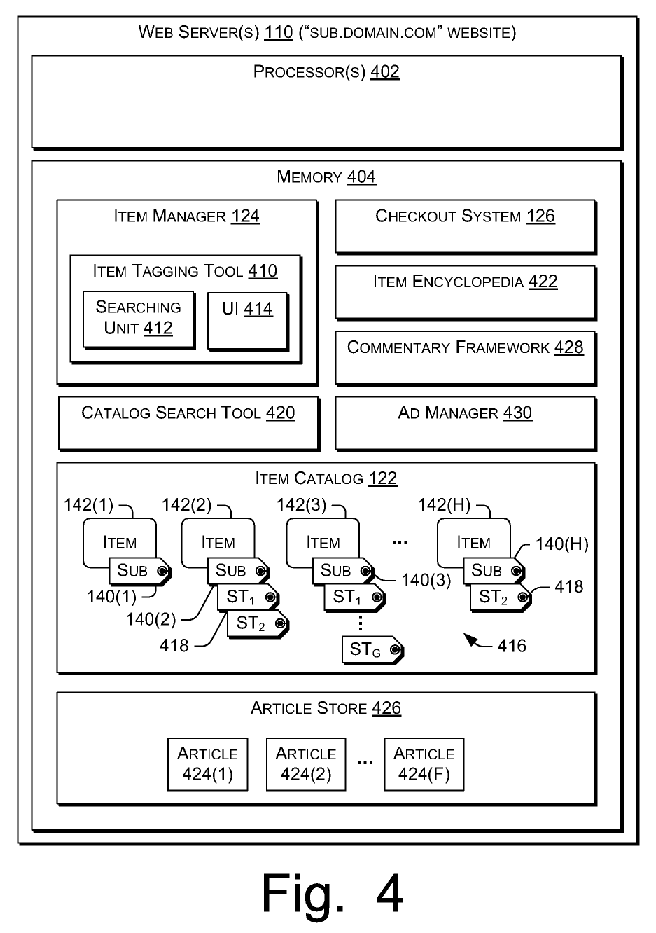

The search tool 308 allows users to search for items and features of those items by searching on tags that may be associated with the items. As noted above, all items are tagged with “camera”, but may also be assigned other tags that are descriptive of the item or specify features or properties of the items. These tags may be assigned by the manufacturer or supplier of the items, the sub-domain site operator, or users. The tagging is free-form in that anyone can add any tag. In some implementations, however, the site operator has final authority over the collection of tags and the items on the sub-domain (e.g., whether to allow users to add tags, or tag other items to add them to the electronic catalog, or otherwise manage existing tags). The tagging structure will be described below in more detail with reference to FIG. 4. In addition to search, the use of tags on items facilitates enhanced navigation and item comparison.

To provide an even richer user experience, the concept-centric electronic marketplace may further support other forums for sharing and discussing cameras. For instance, the sub-domain marketplace might include commentary and analysis of cameras provided by professional photographers. Or, perhaps well-known camera experts might maintain an electronic web-log (or “blog”) discussing the latest innovations in cameras. The sub-domain site might further support a community aspect where a community of hobbyists can comment via discussion boards or add content by creating and/or editing product description or authoring wiki-type articles. To support these rich experiences, the web page 300 may include links 310 to blogs (e.g., “cam-blog”) or to articles (e.g., “wiki-cam”). Here, the links are illustrated with underlining, although in practice the links may be represented using other techniques, such as color variation.

The sub-domain website 104(2) may provide rich authoritative information on the various items available at the concept-centric marketplace. This information may be created and controlled by the site operator and/or created by a community of users. Thus, the sub-domain website 104(2) may provide controls to assist users in creating new articles about items on the concept-centric electronic marketplace. These articles may include any information helpful to a user in learning about the item and deciding whether to purchase the item. Such information may include descriptions of the items, features and specification data, images of the item, intended uses, identities of manufacturers or distributors, accessories, and so on. These articles can be served by the servers 110 to the users to assist the users in better understanding the items.

In a collaborative implementation, the articles are community-authored, where any number of users may add, modify, or delete content contained in the article. Thus, individual users can author new articles and also edit existing articles crafted by other users. The edits can be logged and monitored to prevent malicious entries. Discussion pages, review history, and even the ability to watch pages may further be supported.

The web page 300 may further place advertisements at the electronic marketplace. These advertisements might be, for example, targeted ads to camera users. In this example, an advertisement 312 offers a selection of camera cases. As will be discussed below in more detail, the site operator selects which ads to be placed at the marketplace. When the operator is a community of individuals, the community collectively determines which ads to place on the site. The community-based selection may be accomplished using online processes that democratically elect advertisements based on a consensus of the community.

With reference again to FIG. 1, the user computing devices 102 (also referred to as “client computers” or simply “clients”) may be implemented as any number of computing devices, including as a personal computer, a laptop computer, a portable digital assistant (PDA), a cell phone, a set-top box, a game console, and so forth. Each user computing device 102 is equipped with one or more processors and memory to store applications and data. A browser application provides access to the websites 104(1)-104(W). The browser renders web pages 150 and 152 served by the websites on an associated display, allowing the user to interact with the web pages.

When a user (e.g., user 102(M)) accesses the sub-domain site and purchases an item from the concept-centric marketplace, the checkout system 126 facilitates that purchase. The checkout system 126 facilitates user confirmation of items for purchase, collects payment and shipping information from the customers, provides receipts to the customers, and then hands off delivery of the purchase to a fulfillment system (not shown). It is noted that, in the illustrated implementation, the sub-domain site maintains its own checkout system 126 that is separate and independent from the checkout system 120 of the host domain. The fulfillment of the orders, however, may be facilitated by the fulfillment systems used by the merchant website 104(1) or other website 104(W).

Item Manager Implementation

FIG. 4 illustrates an example implementation of certain components used to implement the concept-centric electronic marketplace on one or more of the web servers 110(1)-110(J) that host the sub-domain website 104(2). The web server(s) 110 have processing capabilities and memory suitable to store and execute computer-executable instructions. In this example, the web server(s) 110 include one or more processors 402 and memory 404. The memory 404 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

The item manager 124 is implemented as software or computer-executable instructions stored in a memory 404 and executed by one or more processors 402. The item manager 124 is responsible for identification, selection, and management of the items 142(1), 142(2), . . . , 142(H) in the electronic catalog 122 exposed by the electronic marketplace. The item manager 124 includes an item tagging tool 410 to identify and tag items to be offered by the concept-centric electronic marketplace.

The item tagging tool 410 has a searching unit 412 and a user interface (UI) component 414. The searching unit 412 is employed to locate items that might be included in the sub-domain marketplace as relating to the concept. These items may reside at the merchant website 104(1) that hosts the general marketplace (i.e., at “domain.com”) and hence the searching unit 412 is used to search items 114 in the item catalog 116 (see FIG. 1). The items may also reside at other merchant websites 104(W) and the searching unit 412 conducts searches of items 130 in the item catalog 132. The UI 414 provides a graphical interface for initiating the searches and selecting items from the search results.

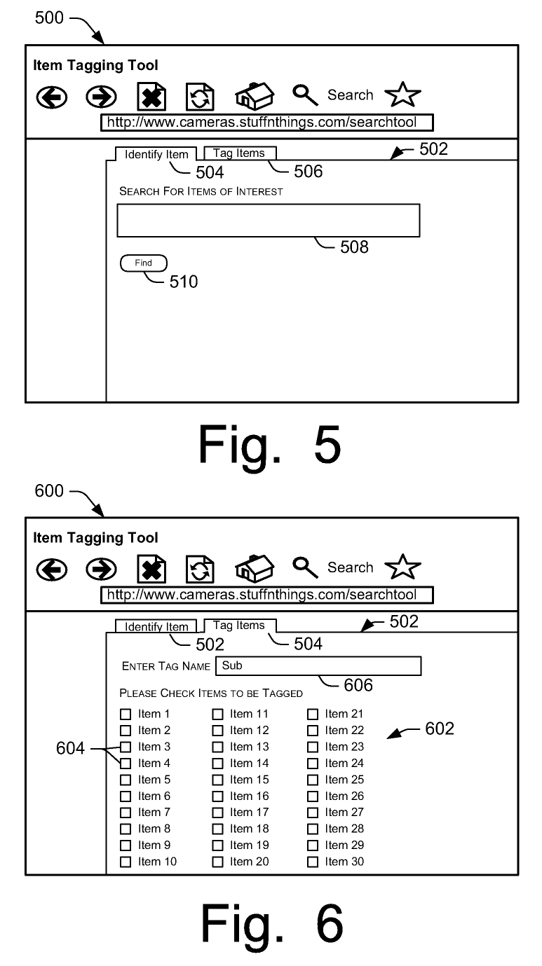

FIGS. 5 and 6 illustrate example screen renderings for the item tagging tool 410. FIG. 5 shows a first screen 500 provided by UI 414 for initiating searches to be conducted by the search unit 414. In this example, the screen 500 is a browser-rendered page with a control pane 502 that steps the sub-domain site operator through the identification and selection process. The control pane 502 has a first tab 504 to invoke a UI that aides in identifying items and a second tab 506 to invoke a UI that assists in tagging the items. In FIG. 5, the “identify item” tab 504 is selected and a search entry box 508 is presented for entry of search terms used to identify possible items to be included at the sub-domain marketplace. The search may be composed as a single term (e.g., “cameras”), as a string of terms (e.g., “digital cameras”), as a Boolean expression (e.g., “cameras” AND (“compact” OR “SLR”)), or as any other input. Once the search criteria are formulated, activation of a control button 510 initiates the search.

FIG. 6 shows a second screen 600 provided by UI 414 to present the results of the search. In this example, the “tag items” tab 506 of the control pane 502 is selected to show a list 602 of items that satisfied the search criteria. The list may be presented in many different formats, wherein the illustrated format is a simple listing of item names. Each item is accompanied by a selection box 604 (or some other control element) that permits the site operator to select those items to be included at the sub-domain marketplace, and other items to be excluded. By checking the appropriate boxes 604, the site operator designates those items to be included at the concept-centric marketplace.

Selected items may then be assigned one or more semantic tags. A tagging entry box 606 allows the operator to enter names of tags to be assigned to the items. In one implementation, all items to be included on the concept-centric electronic marketplace are assigned a common tag that associates the item with the marketplace. For instance, the sub-domain site operator might tag selected items with an initial tag that is identical to, or at least closely related to, the concept. This initial tag may be referred to as the “primary tag”. As shown on screen 600, a primary tag name “sub” is entered into the tagging entry box 606. This primary tag “sub” is identical to the prefix portion of the sub-domain's name “sub.domain.com”. It is further noted that in one implementation, such an identical primary tag may be assigned automatically to each item upon selection of that item from the search list 602.

After initially tagging all items with a primary tag, in certain implementations, the site operator and/or members of the user community (under the operator's control) may also use the item tagging tool 410 to add other tags to the items. These other tags, which are referred to as “secondary tags”. might pertain to properties or characteristics o the items to help facilitate navigation and item comparison.

The item tags are maintained in association with the items through a tagging data structure 416 kept in the item catalog. With reference again to FIG. 4, the primary tag “sub” (referenced by numbers 140(1), 140(2), . . . , 140(H)) is assigned to each item 142(1)-142(H). Continuing the above scenario where the concept pertains to cameras, the operator of the sub-domain “cameras.stuffnthings.com” might assign the primary tag “cameras” to the items by selecting items from the list 602 and entering the term “cameras” in the tag name entry box 606 of the item tagging tool (see FIG. 6).

As also shown in FIG. 4, multiple different secondary tags ST₁-ST_{G} (referenced generally as numbers 418) are assigned to various items, including items 140(2), 140(3) and 140(H). The same secondary tag may be applied to one or many different items (e.g., if the items share the same characteristic or property). For instance, suppose the site operator for the sub-domain “cameras.stuffnthings.com” wants to assign more descriptive tags that callout features or properties of the cameras. Example secondary tags might be “digital”, “Olympus”, “SLR”, “compact”, “underwater”, and so forth. The secondary tags enhance item search and comparison.

A catalog search tool 420 is another software tool that executes on the one or more servers 110 to assist the user in locating items 140(1)-140(H) in the catalog 122. The catalog search tool 420 supports key word searches entered by the user into the search UI 308 (FIG. 3) and searches the catalog 122 for any tags or item metadata matching or relevant to the key word. Once items with the same tags are located, they may be compared. For instance, a user may want to find and compare all compact digital cameras available on the sub-domain “cameras.stuffnthings.com”. The user would enter “compact” and “digital” as key words, and the catalog search tool 420 searches the catalog 122 for items with secondary tags 418 that match these key words.

Once the user locates an item and decides to make a purchase, the transaction is handled by the checkout system 126. The checkout system 126 leads the customer through a series of steps to ascertain the customer's name and address, preferred payment methodology, delivery information, and so forth.

The sub-domain site may further include an item encyclopedia 422, which facilitates creation and management articles 424(1), 424(2), . . . , 424(F) describing the items 140 in the item catalog 122. The articles 424(1)-424(F) are stored in an article store 426.

The sub-domain site may further include a commentary framework 428 to facilitate user discussion and commentary of the products. The framework allows users to enter and post their commentary in any number of formats, including as a discussion board forum, a blog, or other formats. The framework further allows other users to offer feedback on the commentary.

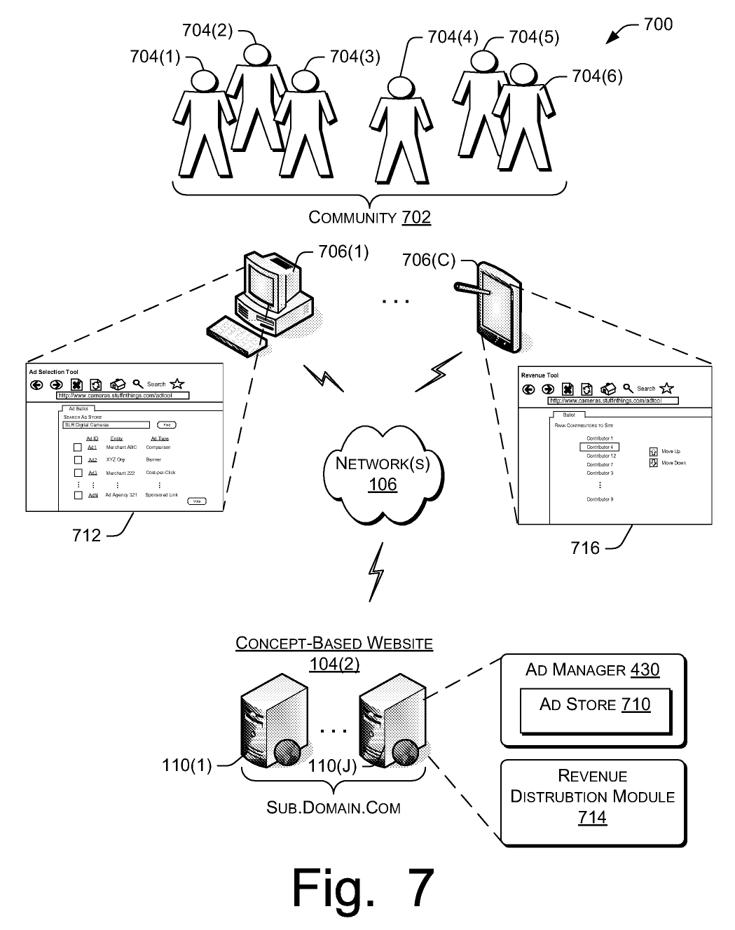

An ad manager 430 is responsible for management of advertisements placed on the electronic marketplace, such as ad 312 in FIG. 2. The ad manager 430 decides what ads to display with what web pages, and may also include functionality to track how many times an ad is presented, whether the user clicked through the ad, and so forth. The ad manager is described below in greater detail with reference to FIGS. 7-10.

Example Community

FIG. 7 shows illustrates an example architecture 700 in which a community 702 of members 704(1)-(6) collectively operates, manages, and/or otherwise contributes to the tag-driven concept-centric electronic marketplace implemented by the server architecture shown in FIGS. 1 and 4. Community members 704 access the concept-based website 104(2) over the network 106 using computing devices 706(1), . . . , 706(C). The illustrated computing devices—desktop computer and PDA—are merely representative, as essentially any electronic device capable of directly or indirectly accessing such sites (whether private or public) may be used.

It is noted that the community is illustrated as having multiple members 704(1)-(6). Any number of members may be included in the community. In practice, the community may initially be formed by a single member or founder. As the website grows and the founder invites others to contribute to the site, the community may grow to have multiple people. Some of these people may act alone (e.g., member 704(4)) or function together in one or more groups. It is further noted that the community members may or may not know one another. Indeed, it is contemplated that the community 702 may be formed by independent contributors who have no formal business ties or organizational structure.

In certain implementations, the size of the community may be limited to a particular size. This size-limited community may be defined at the time of establishing the sub-domain site. Alternatively, a founder or group of founders may establish the original community and then allow new contributors to join until a certain size is met, at which time the group is closed to new members. Any revenue sharing (described below) is shared within the closed community. It is further noted that the community may still encourage others to contribute to the sub-domain site, without allowing them to participate in the revenue sharing group.

When building the community, additional precautions may be taken to ensure that community members are legitimate. In a situation where community members may join and contribute to the site, and share in the revenue, there may be an unintended incentive for an unscrupulous member to set up many fictitious accounts to extract a disproportionate share of the revenue. To prevent this situation, the community may elect to implement processes that authenticate and verify each individual contributor as well as their contributions. Further, the community may decide to expel members from the group when deemed appropriate.

One aspect managed by the community 702 concerns what advertisements to place on the electronic marketplace hosted at the concept-based website 104(2). According to various implementations, the community 702 may select which advertisements to present on the marketplace by democratic processes, where each contributor 704 elects one or more advertisements to place on the site. Another technique is to allow each contributor to rank the advertisements and those advertisements with the highest collective ranking are presented at the electronic marketplace.

In FIG. 7, the ad manager 430 is shown hosted on one or more servers 110(1), . . . , 110(J) to receive input from the various contributors 704 of the community 702 submitted via computing devices 706(1)-706(C) and to select advertisements to be placed on the website 104(2) based on the community input. The ad manager 430 maintains a store 710 that identifies advertisements that others wish to place on the website. The ad store 710 may contain the ads themselves, a listing of the ads, or a list of merchants who wish to place ads on the site. Essentially any types of advertisements may be kept or identified in the ad store 710 including banner advertisements, pop-up advertisements, comparison shopping advertisements, cost-per-click advertisements, and sponsored link advertisements. Although the store 710 is shown hosted at the sub-domain site 104(2), it is noted that the store 710 may be kept by a third party, such as the host website 104(1) (FIG. 1) or any other site.

In one implementation, the contributors 704 can access the ad manager 430 over the network 106 using one of the devices 706 and browse the various advertisements maintained in the store 710. Web pages with the various ads, or a listing of the ads, may be generated by the servers 110 and served to the computing devices 706, where the pages are rendered for viewing. One example page 712 with a list of ads is illustrated as being rendered on device 706(1).

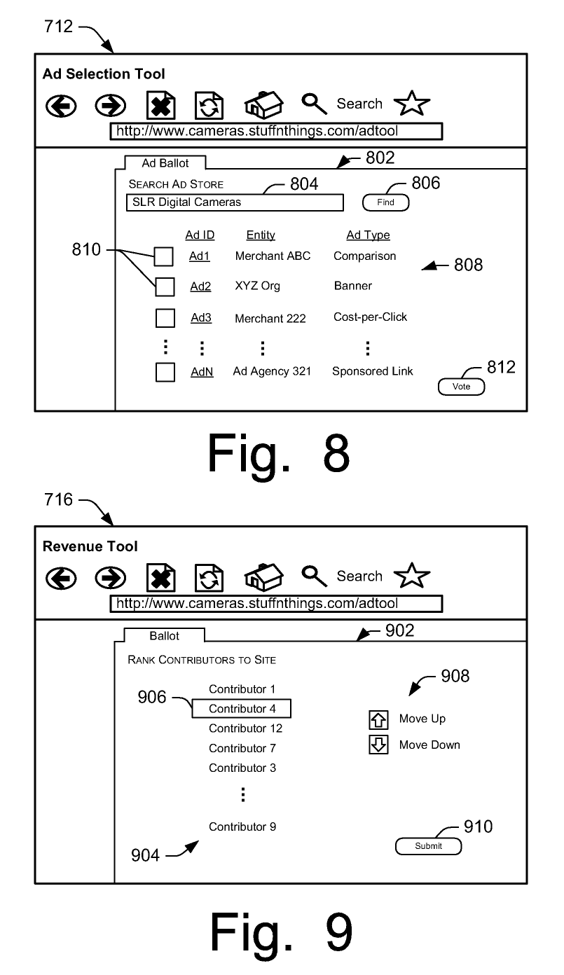

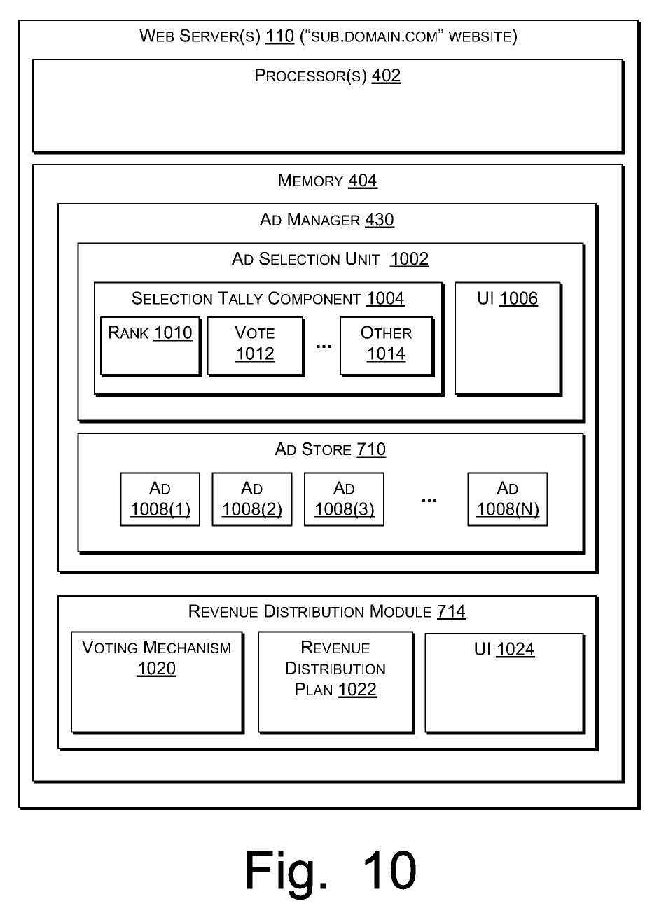

FIG. 8 shows the browser-rendered page 712 in more detail. It provides an ad selection tool interface having an ad ballot pane 802 that allows users to browse advertisements from the ad store 710 and select ads for the sub-domain site. A search field 804 allows the community member to search for ads. The search may be based on any number of criteria, such as product or service type, ad name, ad type, merchant or advertiser name, and so forth. In this example, the contributor entered a search query for advertisements related to “SLR digital cameras”. Upon entering this search, the community member initiates the search by clicking the “Find” button 806 (or pressing the enter key). Advertisements matching the search criteria are then presented in the results space 808. Any number of facts and information pertaining to the ads may be presented, such as an advertisement ID, the merchant or organization who submitted the ad for consideration, and ad type. If not included in the results, the page may include a link to the actual advertisement itself which the community member may follow to retrieve the advertisement for review. In this illustration, the advertisement ID in the results space 808 is also a link to the full advertisement (as represented by the underlining, although other techniques may be used to suggest an active link, such as color differentiation).

The ad ballot pane 802 is further designed to allow contributors to vote electronically for the various ads according to a democratic process. The pane 802 may be configured to allow a contributor to vote for one advertisement, or submit votes for a set number of advertisements (e.g., top N advertisements). This may be done, for example, but actively checking certain boxes 810 adjacent the elected ads. Alternatively, the pane 802 may be configured to permit the user to rank the ads by entering numbers in boxes 810. Once a contributor chooses an ad or set of ads, she submits her vote by actuating the “Vote” button 812.

With reference to FIG. 7, the ad manager 430 receives the votes submitted over the network 106 from the community members. The ad manager 430 tallies the votes and those ads with the highest vote totals, or highest collective ranking, are chosen to be placed on the electronic marketplace website.

It is noted that other factors may come into play when deciding which ads to place on the site. For instance, contributors may argue for or against ads in a discussion forum. Additionally, contributors may be willing to give each other veto power over ads that any one of them finds offensive or otherwise improper.

With continuing reference to FIG. 7, the concept-based marketplace may generate revenue in any number of ways. If the sub-domain site supports a full marketplace, the sale of items associated with the marketplace may generate revenue. If the site merely presents offers to sell such items (i.e., without maintaining its own item inventory), placement of these offers or acceptance of them may also generate revenue. Additionally, placing banner or pop-up ads on the website or using ads or sponsored links that redirect users to other sites may further result in revenue to the sub-domain site. The resulting revenue may be shared among the community of contributors 704 who collectively contribute to the electronic marketplace.

A revenue distribution module 712 is also hosted on the server(s) 110(1)-(J) to distribute revenue generated by the website among the contributors 704 in the community 702. Distributing revenue generated by the ads to the community members provides a useful incentive for the development and maintenance of the site. The community is inclined to develop content and pick advertisements that are relevant to the hobbyists who visit the sub-domain site. As the community selects more relevant ads, more customers click on the ads and/or purchase items advertised on the site, hence rewarding the merchants that place the ads with more business. As ad revenue grows, the community members share in that growth. Thus, the customers are satisfied to find relevant commentary, content, and merchandise; the advertisers are happy with increased ad traffic; and the community is happy to satisfy the readers and generate increasing revenue in the process.

The revenue may be shared in any number of ways, and it may be shared equally or unequally among the contributors. According to one arrangement, the revenue is shared according to a predetermined distribution plan. In another arrangement, the community votes on which contributors receive compensation and the amount of that compensation. As shown in FIG. 7, the community may electronically vote on revenue distribution using the computing devices 706. One particular device 706(C) shows an example page 716 that allows contributors to democratically decide how to distribute the revenue.

FIG. 9 shows the browser-rendered revenue distribution page 716 in more detail. It provides a revenue tool interface with a ballot pane 902 that enables contributors to vote or otherwise decide how revenue generated by the concept-based site is distributed amongst them. In this example interface, a list 904 of the contributors in the community is presented. Within the ballot pane 902, each contributor can rank his or her fellow contributors by placing a focus 906 on a particular contributor and then moving that contributor higher or lower in the ranking by use of action buttons 908. When finished, the contributor submits the rank to the revenue distribution module 714 (FIG. 7) by actuating the “Submit” button 910.

With reference again to FIG. 7, the revenue distribution module 714 collects the various rankings submitted by the contributors and determines a composite ranking. The revenue may then be distributed across the contributors with those ranked higher receiving a higher proportion than those ranked lower.

It is noted that there may be other ways to determine who deserves a share of the revenue. For instance, an interface may simply ask each contributor to name one other person in the community who should be paid (other than himself or herself) and then those with the highest votes receive a larger share of the revenue. Another interface may stipulate that each contributor list only the N people who contributed to such an extent that they should share in the revenue. In another approach, the interface may request each contributor to identify those people who should not share in the revenue, leaving a smaller set of the community to share the revenue (equally or unequally).

Ad Manager Implementation

FIG. 10 illustrates an example components that might be used to implement community-based selection of advertisements for the concept-centric electronic marketplace and revenue distribution models for the community. Similar to FIG. 4, these components are shown implemented on one or more of the web servers 110 that host the sub-domain website 104(2) of “sub.domain.com”. The web server(s) 110 include one or more processors 402 and memory 404. The ad manager 430 and revenue distribution module 714 are shown implemented as software or computer-executable instructions stored in the memory 404 and executed by one or more processors 402.

The ad manager 430 includes an ad selection unit 1002 to facilitate community-based selection of advertisements for placement on the electronic marketplace. The ad selection unit 1002 has a selection tally component 1004 and a user interface (UI) component 1006. The UI 1006 provides a graphical interface that allows the contributors to vote or otherwise offer input about which ads to place on the site. One example interface is shown in FIG. 8. The UI 1006 further enables contributors to browse ads, see a list of ads, or view the ads themselves. Such ads may be kept in the ad store 710, as represented by ads 1008(1)-(N).

The selection tally component 1004 is employed to tally input or votes from the community of contributors who are choosing the advertisements. The selection tally component 1004 may use any number of mechanisms for ascertaining which ads are favored by the community, including a ranking mechanism 1010 that tallies the rankings submitted by the community, a voting mechanism 1012 that tallies votes for one or more ads, and other mechanisms 1014. The contributors submit their votes or rankings using the UI 1006, and the selection tally component 1004 compiles their input using one or more of these mechanisms.

In some cases, the selection tally component 1004 employs a simple majority or straight ranking to determine which ads are favored. In other implementations, the selection tally component 1004 may consider other decision factors, such as potential ad revenues, duration of ads, merchant that submitted ad, and so forth. For instance, ads may be weighted to reflect which ones are likely to generate higher revenue for the community, and this weighting is taken into consideration along with the contributor votes.

The revenue distribution module 714 is provided to distribute revenue generated by the website among the independent contributors in the community. The revenue distribution module 714 may include a voting mechanism 1020, a revenue distribution plan 1022, and/or a UI 1024. The UI 1024 supports a graphical interface through which contributors can discuss and decide how to distribute the revenue amongst them. One example interface is shown in FIG. 9, which allows contributors to rank the members of the community as a way to distribute revenue.

The voting mechanism 1020 and the revenue distribution plan 1022 offer two example techniques for distributing revenue. With the distribution plan 1022, the revenue distribution module 714 computes shares for contributors according to a pre-negotiated contract that stipulates how contributors are to be paid. This plan 1022 may be discussed offline by the community, or through an online discussion forum. As another approach, the contributors may periodically vote on how individual contributors are compensated. In this case, the voting mechanism 1020 supports a process in which contributors may place votes or submit rankings in an effort to democratically determine how revenue should be distributed. Recall that these members may not know one another personally, so the voting mechanism 1020 attempts to provide a fair and objective approach to distributing revenue among the various contributors.

Operation

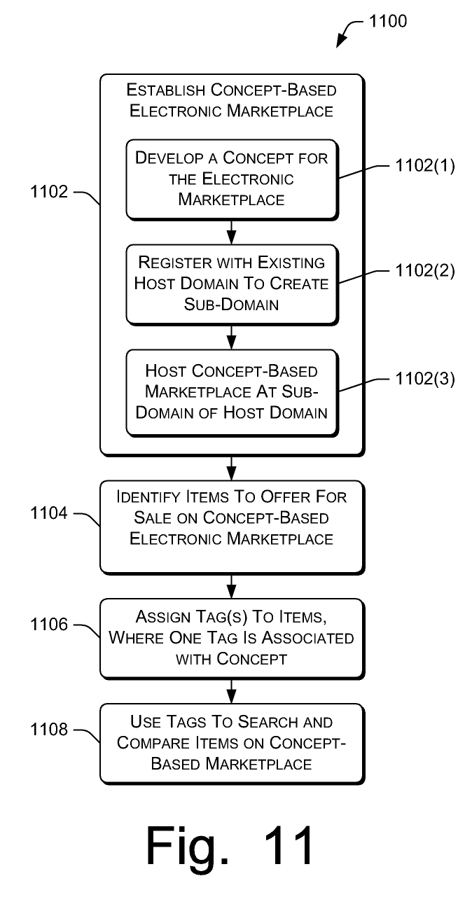

FIG. 11 illustrates an example process for launching and operating a concept-centric electronic marketplace as a sub-domain website. The process is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

For discussion purposes, the process is described with reference to the architecture 100 of FIG. 1, and the web server system of FIG. 4. In particular, many acts described below may be implemented and performed by the item manager and item tagging tool.

FIG. 11 shows a process 1100 for launching a concept-centric electronic marketplace as a sub-domain website. At 1102, the concept-centric electronic marketplace is established. This operation may be viewed as a series of sub-operations 1102(1)-1102(3). At 1102(1), a concept for the electronic marketplace is developed. The concept may result in any logical grouping of items, and may be based on item types (e.g., cameras, ties, barbeques, etc.), themes (e.g., travel, cooking, etc.), common properties (e.g., black items, small items, etc.), and the like.

At 1102(2), a prospective owner of the concept-centric website registers with the host domain to create a sub-domain. The sub-domain is named according to the concept. Thus, if a prospective owner of a sub-domain site wants to launch a marketplace centered on the theme “travel”, the prospective owner might submit a registration to the operator of the host domain, say “domain.com”, to register the sub-domain “travel.domain.com”. If another prospective owner of a different sub-domain site wants to launch a marketplace centered on items with the property of being small, the prospective owner might register the sub-domain “tinyitems.domain.com”. It is noted that the host operator may allow any number of sub-domains to be established.

In some situations, the host domain operator may decide to award sub-domains on a first-come-first-served basis. Thus, the site operator who is first to register a particular concept is awarded a corresponding sub-domain. In other situations, however, the host domain operator may elect not to release the requested sub-domain name, but instead may ask the registrant to choose a more narrowly descriptive name and wait to award the broader sub-domain name to the operator that shows the most promise at best operating that sub-domain. For example, suppose there are a number of registrants for electronic marketplaces that pertain to the concept of cameras. Rather than registering the sub-domain “cameras.stuffnthings.com” (which is broadly descriptive of the type of goods) to the first registrant, the host domain operator may ask every registrant to choose a more descriptive, narrower name, such as “bobscamearas.stuffnthings.com” or “premiumcameras.stuffnthings.com”. Then, over time, the host domain operator can watch how the various operators perform and ultimately award the broader name “cameras.stuffnthings.com” to the sub-domain operator that performs the best. This performance may be based on any number of criteria such as community feedback, traffic flow to the sub-domain site, sales volume, and so forth.

At 1102(3), the newly created sub-domain is hosted at the host domain. For example, the servers used to host the domain “stuffnthings.com” are also used to host the sub-domain “camera.stuffnthings.com”, as well as any number of other sub-domains. With reference to FIG. 1, the servers 108(1)-108(N) and 110(1)-100(J) are operated by the same entity, and are used to host both the host website 104(1) and concept-centric website 104(2). It is noted that in certain other implementations, the sub-domain may be hosted by servers independent from the servers for the host domain. Also, a separate entity may own the independent servers. However, in each situation, the operator of the sub-domain registers with the host domain.

After the concept-centric electronic marketplace is established, items to be offered for sale on the electronic marketplace are identified (block 1104 in FIG. 11). The items relate in some manner to the concept around which the marketplace is developed. Thus, for a niche marketplace for cameras, the items may include cameras, lenses, film or memory sticks, and accessories. In one implementation, the items may be identified from the item catalog of the host domain. For example, with reference to FIG. 1, items 142 to be offered on the concept-centric website 104(2) may be identified by searching the item catalog 116 of the host website's marketplace. In one business arrangement, the host website may invite and encourage other operators to set up concept-centric marketplaces and thus make the tools available (such as the item tagging tool 410) to search and select items from its item catalog.

The items may be identified using the exemplary item tagging tool 410. As illustrated in FIGS. 5 and 6, the item tagging tool exposes a user interface that allows the sub-domain operator to enter key words to search for possible items. Example search words might be “camera”, “lens”, “photography”, “pictures”, and so forth. The search may be directed to one or more other item catalogs for websites with whom the operator has a business arrangement. The search results are then presented, as represented in FIG. 6, and the operator can select which items to include on the concept-centric electronic marketplace.

In other implementations, the items may be identified from one or more other websites. Again with reference to FIG. 1, items 142 to be offered on the concept-centric website 104(2) may be found by searching the item catalog 132 of another website 104(W). The same item tagging tool 410 may be used to search these databases as well.

Once items are identified, the items are assigned one or more tags (block 1106 in FIG. 11). At least one tag is a primary tag that is identical to, or otherwise closely associated with the concept. For the concept-centric site “cameras.stuffnthings.com”, the primary tag might be “cameras” or “camera”. The primary tag is assigned by the site operator when initially launching the sub-domain site. The tag assignment may be accomplished using the item tagging tool, and particularly, via the UI 600 shown in FIG. 6. As shown in that figure, the sub-domain operator can elect certain items from the list 602 and assign a tag via tag entry field 606. The tag is then maintained in association with the item through a data structure in the item catalog 122, as shown in FIG. 4.

Other secondary tags may also be assigned to the items, either by the sub-domain operator or by users. Any number of secondary tags may be assigned to each item. These secondary tags are also associated with the items through the data structure. Using these secondary tags, users may search and compare items on the concept-centric electronic marketplace (block 1108). For example, suppose a visitor to the sub-domain marketplace “cameras.stuffnthings.com” wants to find digital cameras and thus enter key words “digital” and “cameras”. The site search engine locates all items in the item catalog with a secondary tag “digital”. (Note that all items might be tagged with the primary tag “cameras”, so the search engine is configured filter results on the primary tag). From the search results, the visitor may compare the various items or filter them further to compare ones with additional characteristics, such as comparing digital cameras that are also “compact”. With the addition of this keyword, the list of items is further pared to those with a “compact” tag.

It is noted that discovery of items may be accomplished in ways other than through use of tags. For instance, in another approach, keyword searches may return a list of items and a user selects certain items of interest by highlighting the items, checking an associated box, or through other UI mechanisms.

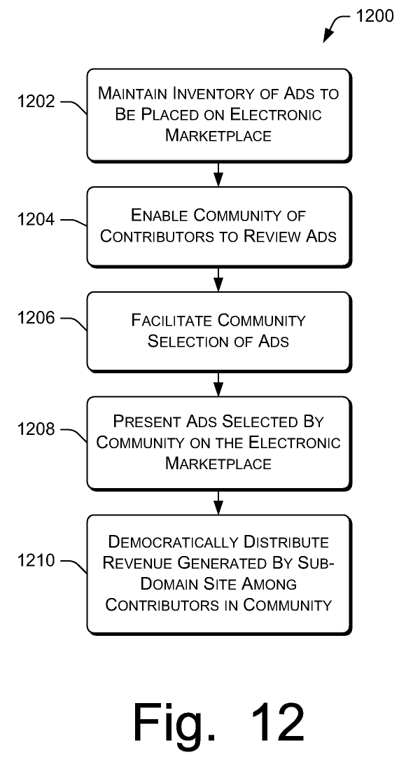

FIG. 12 illustrates an example process 1200 for determining which advertisements to position on the electronic marketplace. For discussion purposes, the process is described with reference to the architecture 700 of FIG. 7, and the web server system of FIG. 10. In particular, many acts described below may be implemented and performed by the ad manager 430 and the revenue distribution module 714.

At 1202, an inventory of advertisements that others submit for consideration to be placed on the concept-centric electronic marketplace is maintained. The advertisements may be submitted in response to a request by the community that operates the site, or they may be unsolicited. As one example, the inventory may be maintained in the ad store 710 (FIGS. 7 and 10). The inventory may include a listing of ads and relevant information (e.g., ad type, merchant or sponsor, fee generated by ad, etc.). The inventory may also contain the ads themselves, including the graphics and any animation or video features. Multiple ads 1008(1)-(N) are illustrated in ad store 710.

At 1204, the contributors in the community are allowed to review the ads to determine which ads should go on the site. In one implementation, the contributors may access the ad store 710 remotely and view the ads using a browser-based tool, such as that illustrated in FIG. 8. Having reviewed the ads, the community selects a subset of the ads for placement on the site (block 1206). In the described implementation, the ad manager 430 facilitates community-based selection of the advertisements. This may be accomplished in many ways, including by vote (e.g., ads with a threshold number of votes are placed, or those ads with the most votes, etc.) or by having each contributor rank the advertisements. The voting process may also be conducted online via an electronic ballot, such as that shown in FIG. 8.

At 1208, the advertisements selected by the community are presented on the electronic marketplace. The community may further provide input on management of the selected ads, including placement of the ads, duration that they appear, and so forth.

At 1210, any revenue generated by the advertisements (as well as any revenue resulting from the sale or offer of items) is distributed to the contributors according to an online democratic process. In one implementation, the revenue distribution module 714 provides for revenue sharing among the community members. All or a subset of the community may receive some share in the revenue. Moreover, the shares may be equal or unequal. As noted above, the community members may elect to divvy up revenues according to a pre-arranged distribution plan 1022, or they may vote to award revenue to various members using a voting mechanism 1020 exposed via an interface, such as the page 716 shown in FIG. 9.

Revenue Sharing with Host and Other Domains

When registering and launching a concept-centric marketplace as a sub-domain website, the sub-domain operator enters into a business relationship with the domain operator. This relationship allows the sub-domain operator to use the sub-domain and to market items that are also included on the merchant website of the host domain. This relationship may or may not be exposed to the customers who visit the two sites. As part of this relationship, the domain and sub-domain operators may agree to a revenue sharing arrangement resulting from the sale of items on the concept-centric marketplace. FIGS. 8 and 9 illustrate different business models for sharing revenue among operators of the host domain, sub-domain, and possibly even third party domains.

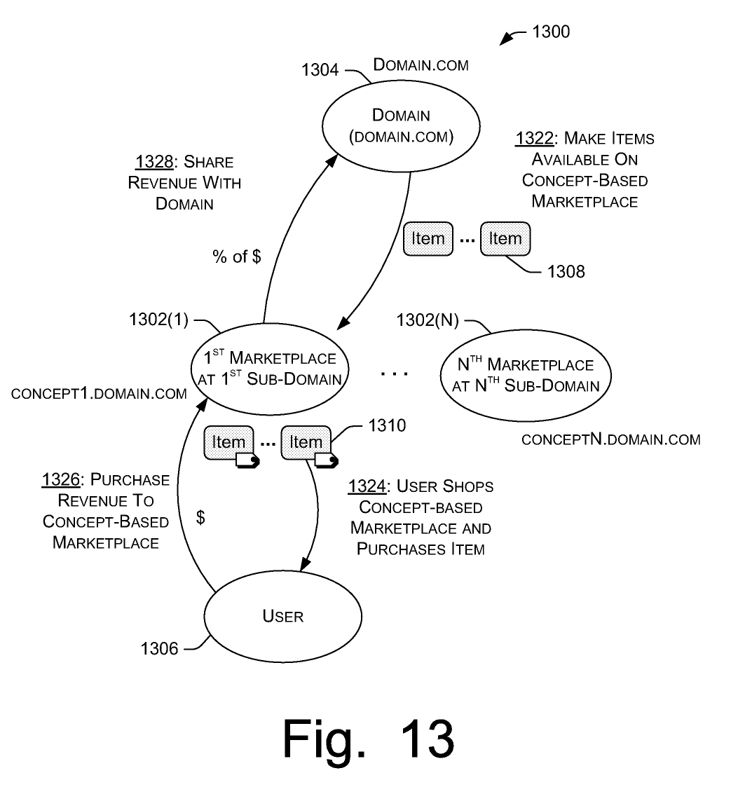

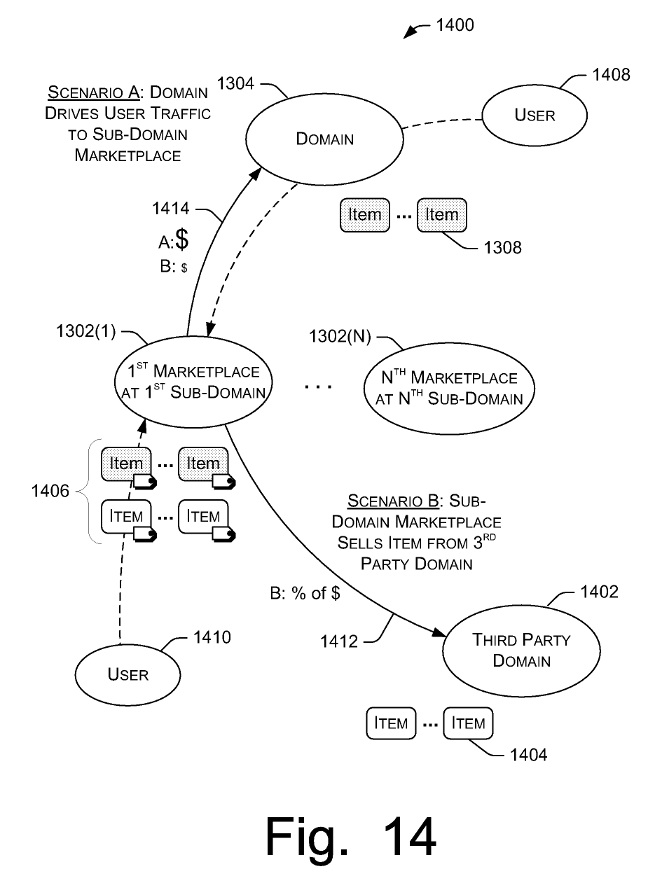

FIG. 13 shows a first revenue sharing arrangement 1300 in which multiple sub-domains 1302(1), . . . , 1302(N) have registered with a host domain 1304 to operate concept-centric marketplaces. For this discussion, suppose that the host domain 1304 also operates its own electronic marketplace that is accessible at a domain named “domain.com”. As illustrated, any number of proprietors may register with the domain 1304 to operate concept-centric marketplaces.

For purposes of discussion, suppose the first sub-domain 1302(1) operates a niche marketplace based around a first concept, and this marketplace may be found on the World Wide Web at “concept1.domain.com”. Similarly, the N^{th} sub-domain 1302(N) operates a different niche marketplace based around another concept, and this N^{th} marketplace may be found on the World Wide Web at “conceptN.domain.com”. A user 1306 may visit any one of the online electronic marketplaces at the host domain 1304 or one of the sub-domains 1302(1)-1302(N). The user 1306 may go directly to the particular electronic marketplace by entering the domain name into a browser, or be referred to one of the sub-domains 1302(1)-1302(N) via a link exposed at the host domain 1304.

The concepts for each sub-domain may be distinct form one another (e.g., jewelry, tools, ties, telescopes, DVD movies, etc.), or groups of sub-domains might share a common concept. As an example of this latter situation, suppose multiple proprietors are interested in registering sub-domains developed to market cameras. Rather than limiting registration to one sub-domain for cameras, the host domain may choose to register multiple sub-domains for cameras, with each sub-domain having its own unique domain name (e.g., “premiumcameras.domain.com”, “bobscamearas.domain.com”, etc.).

One particular business arrangement between the host domain 1304 and the first sub-domain 1302(1) will now be described with reference to FIG. 13. In this arrangement, the sub-domain 1302(1) shares revenues with the host domain 1304 in exchange for being permitted to operate the sub-domain and for having access to sell items available at the host domain.

At 1322, the first sub-domain 1302(1) establishes its electronic marketplace by selecting from items 1308 that are marketed and sold by the host domain 1304. The identified items are tagged with a primary tag to associate them with the first electronic marketplace at the first sub-domain 1302(1), as represented by tagged items 1310. At 1324, the user 1306 visits the marketplace at the first sub-domain 1302(1) and purchases one of the items. At 1326, purchase revenue is passed from the user 1306 to the sub-domain 1302(1). At 1328, a percentage of that revenue is shared with the host domain 1304. In this arrangement, the host domain receives less revenue than had it sold the item directly to the user, but is expecting to increase overall revenues as a result of fostering many niche marketplaces that sell incrementally more items.

It is further noted that the operator of the sub-domain may be a group of individuals. In this case, the individuals may further elect to share the portion of the revenue allocated to the sub-domain. This secondary revenue sharing may be decided in a number of ways, including by contribution level, contract, or other techniques.

FIG. 14 shows a revenue sharing model 1400 to describe two other possible revenue sharing arrangements among the operators of the sub-domain and host domain, as well as with another domain run by a third party. As illustrated, multiple sub-domains 1302(1), . . . , 1302(N) have registered with the host domain 1304 to operate concept-centric marketplaces. The host domain 1304 operates an electronic marketplace that sells items 1308 and a third party domain 1402 operates a different electronic marketplace that sells other items 1404.

The first sub-domain 1302(1) hosts an electronic marketplace that sells items selected in part from items 1308 of the host domain 1304 and in part from items 1404 of the third party domain 1402. The items selected from the different domains are tagged with a common primary tag to associates the items with the electronic marketplace at the first sub-domain 1402(1), as represented by tagged items 1406.

In a first scenario A, a user 1408 visits the host domain 1304. During that visit, the host domain 1304 refers the user to the sub-domain 1302(1), as pictorially represented by the dashed line from the user 1408 through the domain 1304 to the sub-domain 1302(1). The user then purchases an item 1406 from the first electronic marketplace at the sub-domain 1302(1). Part of the revenue from this purchase is shared by the sub-domain operator with an operator of the host domain 1304 for referral of the customer. Additionally, the amount of revenue shared with the host domain 1304 for this referral may vary depending upon whether the customer 1408 purchased an item 1406 that could also be found on the host domain 1304 (i.e., item 1308) or on the third party domain 1402 (i.e., item 1404), where more revenue is shared in the former case and less revenue is shared in the latter case. Moreover, the revenue sharing arrangement for customer referral may be entirely separate and distinct from any sharing arrangement pertaining to the sale of items that are also found on the host domain 1304, as described above with respect to FIG. 13.

In a second scenario B, another user 1410 visits the sub-domain 1302(1) without being referred by the host domain 1304. Upon purchase of an item 1404 that was originally selected from the third party domain 1402 for sale on the concept-centric marketplace of the sub-domain 1302(1), a portion of the revenue is shared with operators of the third party domain 1402, as represented by monetary flow arrow 1412. Additionally, a small portion of the revenue may be shared with the host domain 1304 for providing permission to operate the sub-domain. In this scenario, however, the amount of revenue that the host domain 1304 receives is smaller than the revenue received in scenario A described above, as represented by the different sized “$” signs for scenarios A and B in the monetary flow arrow 1314 from sub-domain 1302(1) to domain 1304.

Thus, there are many revenue sharing components that may be considered when establishing a relationship between the host domain 1304 and each of the sub-domains 1302(1)-1302(N). These components include, but are not limited to, a component for being permitted to operate a sub-domain to the domain, a component for selling an item that is also marketed and sold by the host domain, and a component for receiving a referral from the host domain.

Revenue Sharing Among Contributors

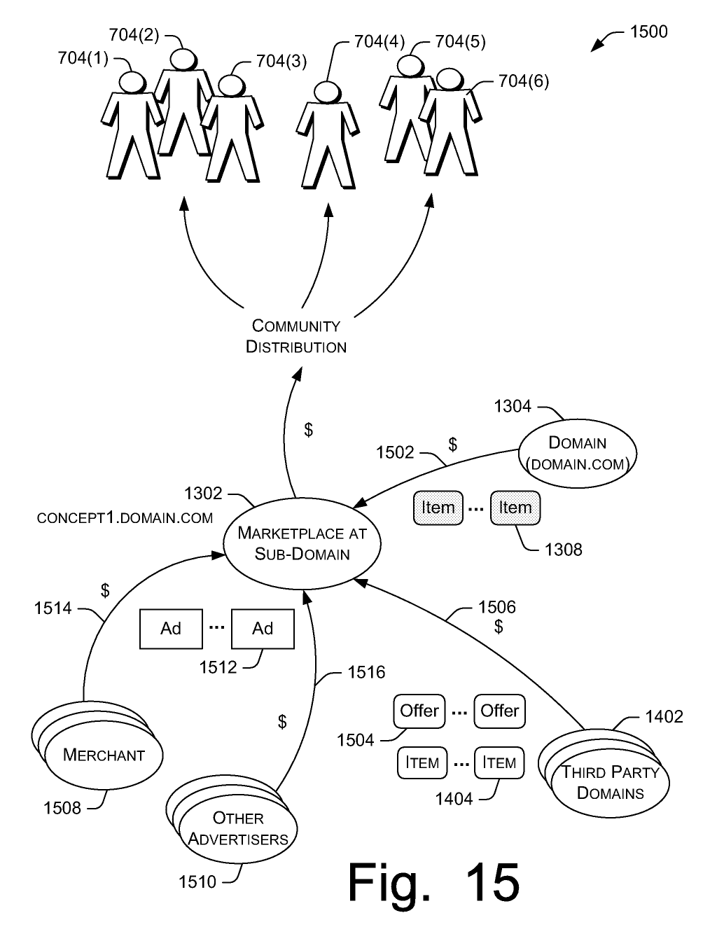

FIG. 15 shows a revenue sharing arrangement 1500 in which revenue generated by the concept-based marketplace 1302 is distributed among the contributors 704(1)-704(6). As above, a sub-domain 1302 (e.g., “concept1.domain.com”) is registered with a host domain 1304 (e.g., “domain.com”) to operate a concept-centric electronic marketplace. The sub-domain 1302 generates revenue in a number of ways. For instance, the marketplace may market items 1308 from the host domain, and the sales of those items results in payment from the domain 1304, as represented by revenue arrow 1502. The marketplace may further present offers 1504 to sell products/services available from third party domains 1402, resulting in payment from the third party domains as represented by revenue arrow 1506.

Merchants 1508 and other advertisers 1510 may also submit ads 1512 for placement on the electronic marketplace website. The merchants and advertisers agree to pay sub-domain operators for displaying the ads or when visitors to the sub-domain affirmatively act on those ads (e.g., clicking through an ad to be redirected to another site, actuating a sponsored link, etc.). This revenue flow is exhibited by arrows 1514 and 1516.

The revenue collected by the sub-domain is used to cover expenses and operational costs of running the marketplace. Any remaining revenue may then be paid out to the community 702, with the contributors 704(1)-(6) deciding who among them get what. As discussed above, the contributors may divide the revenue based on a vote, or by ranking people according to their contributions to the success of the website, or by a prearranged distribution plan.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
establishing an electronic marketplace associated with a concept, wherein the electronic marketplace is located at a sub-domain of a domain website and at least part of a domain name of the sub-domain is related to the concept; and
presenting advertisements at the electronic marketplace at the sub-domain that are selected by a community of contributors who collectively contribute to the electronic marketplace.

2. A method as recited in claim 1, wherein the community of contributors represents a first entity that is separate and distinct from a second entity that operates the domain website.

3. A method as recited in claim 1, wherein the domain name of the sub-domain is structured as “sub.domain.com”, and a prefix portion “sub” of the domain name includes, at least in part, a word related to the concept.

4. A method as recited in claim 1, wherein the contributors select the advertisements by voting.

5. A method as recited in claim 1, wherein the contributors select the advertisements by ranking the advertisements and those advertisements with a highest collective ranking are presented at the electronic marketplace.

6. A method as recited in claim 1, further comprising facilitating collaborative development of item descriptions by the community of contributors.

7. A method as recited in claim 1, further comprising sharing revenue generated by the electronic marketplace between the community that operates the electronic marketplace at the sub-domain and an operator of the domain website.

8. A method as recited in claim 1, further comprising sharing revenue generated by the electronic marketplace among the contributors in the community.

9. A method as recited in claim 1, further comprising sharing revenue resulting from presenting the advertisements among the contributors in the community.

10. A method as recited in claim 1, wherein the electronic marketplace located at the sub-domain is a first electronic marketplace and a second electronic marketplace is located at the domain website, the method further comprising:
facilitating item selection and purchase using a first checkout system for items on the first electronic marketplace at the sub-domain; and
facilitating item selection and purchase using a second checkout system for items on the second electronic marketplace at the domain website, wherein the second checkout system is independent of the first checkout system.

11. A method as recited in claim 1, further comprising:
identifying items to be offered at the electronic marketplace; and
associating, with the items, semantic information pertaining to the concept.

12. A method as recited in claim 11, wherein the identifying comprises searching for items available on one or more other electronic marketplaces and enabling selection of certain items for inclusion at the electronic marketplace.

13. A method as recited in claim 12, wherein the searching and selection are performed using a graphical user interface.

14. A method as recited in claim 11, wherein the associating comprises tagging the items with tags associated with the concept.

15. A method as recited in claim 14, wherein the tagging comprises assigning a primary tag to each of the items, and assigning one or more secondary tags to one or more of the items.

16. A method as recited in claim 11, wherein the domain name of the sub-domain is structured as “sub.domain.com”, where a prefix portion “sub” of a domain name refers to the concept, and the associating comprises assigning a tag with a name that is identical to the prefix portion.

17. One or more computing devices, comprising:
one or more processors; and
memory to store computer-executable instructions that, when executed by the one or more processors, perform the method of claim 1.

18. A method comprising:
establishing an electronic marketplace associated with a concept, wherein the electronic marketplace is located at a sub-domain of a domain website and at least part of a domain name of the sub-domain is related to the concept;
generating revenue as a result of at least one of (1) presenting advertisements at the electronic marketplace at the sub-domain, (2) offering items for sale at the electronic marketplace, (3) selling items via the electronic marketplace, or (4) redirecting users to other websites; and
sharing the revenue among a community of members who collectively contribute to the electronic marketplace.

19. A method as recited in claim 18, wherein the community begins with a single member, and further comprising commencing the sharing of revenue upon addition of additional members to the community.

20. A method as recited in claim 18, wherein the sharing comprises distributing the revenue to various members according to a predefined agreement.

21. A method as recited in claim 18, wherein the sharing comprises:
enabling individual members to submit a ranking of the members; and
distributing the revenue to the members according to a collective ranking of the members.

22. A method as recited in claim 18, further comprising sharing the revenue between the multiple individuals collectively as one entity and a second entity that operates the domain website.

23. A method as recited in claim 22, wherein the revenue resulting from (2) and (3) is shared at different proportions depending upon whether purchasers were referred to the electronic marketplace from the domain website or from another source.

24. A method as recited in claim 18, wherein the sub-domain has a domain name structured as “sub.domain.com”, where a prefix portion “sub” of the domain name refers to the concept, and further comprising tagging the items offered at the electronic marketplace with a tag having a name that is identical to the prefix portion.

25. One or more computing devices, comprising:
one or more processors; and
memory to store computer-executable instructions that, when executed by the one or more processors, perform the method of claim 18.

26. A method comprising:
hosting a first electronic marketplace at a domain;
hosting at least one second electronic marketplace at a corresponding sub-domain to the domain, wherein the second electronic marketplace is developed around a concept;
enabling a community of independent operators to collectively operate the second electronic marketplace at the sub-domain by at least one of (1) identifying items to be offered for sale at the second electronic marketplace and (2) selecting which advertisements to be presented at the second electronic marketplace; and
sharing any revenue generated as a result of sales of the items and presentation of the advertisements among the independent operators in the community.

27. A method as recited in claim 26, wherein the revenue is shared in a non-equal distribution among the independent operators.

28. A method as recited in claim 26, wherein the sharing further comprises distributing the revenue to various ones of the independent operators according to a distribution plan approved by vote of the community of independent operators.

29. A method as recited in claim 26, wherein the sub-domain has a domain name structured as “sub.domain.com”, where a prefix portion “sub” of the domain name refers to the concept.

30. A method as recited in claim 26, further comprising assigning one or more tags to the items, wherein at least one tag is associated with the concept for the second electronic marketplace.

31. A method as recited in claim 26, further comprising facilitating collaborative development of item descriptions on the second electronic marketplace by the community of independent operators.

32. One or more computing devices, comprising:
one or more processors; and
memory to store computer-executable instructions that, when executed by the one or more processors, perform the method of claim 26.

33. A server system comprising:
one or more processors;
a memory, accessible by the one or more processors; and
an ad manager stored in the memory and executable on the one or more processors to facilitate selection of advertisements to place on a website by a community of independent contributors who collectively contribute to the electronic marketplace.

34. A server system as recited in claim 33, wherein the website comprises an electronic marketplace.

35. A server system as recited in claim 33, wherein the advertisements are selected from a group of ad types comprising banner advertisements, pop-up advertisements, comparison shopping advertisements, cost-per-click advertisements, and sponsored link advertisements.

36. A server system as recited in claim 33, wherein the ad manager comprises a selection tally component to tally input from the community of contributors in choosing the advertisements to place on the website.

37. A server system as recited in claim 33, wherein the ad manager comprises a voting unit that tallies votes placed by ones of the contributors in the community when choosing the advertisements to place on the website.

38. A server system as recited in claim 33, wherein the ad manager comprises a ranking unit that ranks the advertisements based on rankings provided by ones of the contributors in the community.

39. A server system as recited in claim 33, further comprising a revenue distribution module to distribute revenue generated by the website among the independent contributors in the community.
